(19) United States
(12) Patent Application Publication
(10) Pub. No.: US 2015/0040378 A1
(43) Pub. Date: Feb. 12, 2015

(54) METHOD FOR MANUFACTURING LASER SCANNERS

(71) Applicant: Hand Held Products, Inc., Fort Mill, SC (US)

(72) Inventors: Kevin Saber, Sewell, NJ (US); Robert Hugh Brady, Brookfield, CT (US); Stephen Colavito, Garnet Valley, PA (US); Chen Feng, Snowhomish, WA (US); David Wilz, Sewell, NJ (US); Joseph A. Walczyk, Syracuse, NY (US)

(21) Appl. No.: 13/961,408

(22) Filed: Aug. 7, 2013

(51) Int. Cl. G06K 7/10

(52) U.S. Cl. CPC G06K 7/10881
USPC 29/592.1

(57) ABSTRACT

A method for manufacturing laser scanners is provided. Laser scanners are configured to drive their light-deflecting assemblies at a fixed drive frequency. By selecting for inclusion in the laser scanners only those light-deflecting assemblies that have resonant oscillation frequencies falling within a specified range, operation of the laser scanners remains within engineering tolerances even through extreme environmental changes. Moreover, the method results in laser scanner having greater unit-to-unit consistency during operation even in extreme environments.

### FIELD OF THE INVENTION

The present invention relates to laser scanners. More particularly, the present invention relates to a method of manufacturing laser scanners.

### BACKGROUND

Laser scanners are widely-used devices for decoding machine-readable indicia such as barcodes. Laser scanners typically operate by sweeping a laser beam across the laser scanner's field of view. If the field of view contains an indicia, the laser scanner receives the laser light that is reflected off the indicia and converts the optical signal into an electrical signal that can be decoded by the laser scanner.

To achieve the effect of sweeping the laser across the field of view, the laser scanner typically has a laser source directing a laser beam at a light-deflecting assembly. The light-deflecting assembly typically consists of a mirror and a permanent magnet mounted to an oscillating element commonly referred to as a flipper. The light-deflecting assembly is driven in an oscillating motion by an electromagnet that interacts in a push-pull manner with the permanent magnet. The oscillating motion of the light-deflecting assembly moves the mirror in such a way that when the laser light deflects off of the mirror it creates the desired sweeping pattern of the laser across the field of view.

The closer that the laser scanner can drive the light-deflecting assembly to oscillate at the light-deflecting assembly's resonant oscillation frequency, the less power that the laser scanner uses. For this reason, laser scanners have typically been configured to drive their light-deflecting assemblies at an oscillation frequency that is near the light-deflecting assembly's resonant oscillation frequency. Because operating the light-deflecting assembly at its resonant oscillation frequency has tended to lead to instability and unit failure, laser scanners typically are not configured to drive the light-deflecting assembly precisely at the resonant oscillation frequency. Even where the laser scanner is configured with a fixed drive frequency that is not the same as the resonant oscillation frequency, operational variables such as temperature fluctuations or aging can result in changes to the oscillation frequency of the light-deflecting assembly. To avoid permitting these changes to cause the light-deflecting assembly to operate at its resonant oscillation frequency, laser scanners have typically incorporated monitoring systems for monitoring the oscillation frequency of the light-deflecting assembly. When the oscillation frequency of the light-deflecting assembly approaches the resonant oscillation frequency, the laser scanner adjusts the drive frequency to keep the oscillation frequency of the light-deflecting assembly within an acceptable range.

Although this technique of manufacturing laser scanners to monitor the oscillation frequency and adjust the drive frequency is effective at maintaining the desired oscillation frequency of the light-deflecting assembly, it is not without cost. Implementing the necessary monitoring and drive-adjustment capabilities complicates the manufacturing process and typically leads to increased costs for manufacturing the laser scanners. Not only do designers have to design and implement the monitoring and adjustment systems, but they have to account for the variations in the drive frequency and oscillation frequency in configuring the laser scanner to receive and decode the reflected optical signals from the indicia. In addition, the technique of varying the drive frequency during operation can lead to variations in spot speed between different machines, which can affect the performance of the laser scanner. Furthermore, running the self-diagnostics required to monitor the oscillation frequency of the light-deflecting assembly can result in increased startup time for the laser scanner or otherwise impede its usability.

Therefore, a need exists for a method for manufacturing laser scanners that can operate their light-deflecting assemblies with the minimum necessary power while maintaining operational stability and reliability. A need also exists for a less complicated and less costly method for manufacturing laser scanners that results in greater consistency in performance between laser scanners.

### SUMMARY

Accordingly, in one aspect, the present invention embraces a method for manufacturing laser scanners. A plurality of light-deflecting assemblies for use in laser scanners is provided. Only those light-deflecting assemblies that have a resonant oscillation frequency between a target minimum resonant oscillation and a target maximum resonant oscillation frequency are selected from the plurality of light-deflecting assemblies. Those light-deflecting assemblies, if any, that have a resonant oscillation frequency either (i) below a target minimum resonant oscillation frequency or (ii) above a target maximum resonant oscillation frequency are rejected from the plurality of light-deflecting assemblies. Laser scanners are assembled, each laser scanner including a selected light-deflecting assembly. Each laser scanner is configured to drive its corresponding, selected light-deflecting assembly at a target fixed drive frequency, whereby all of the assembled laser scanners employ substantially the same fixed drive frequency.

In an alternative embodiment, the target minimum resonant oscillation frequency is less than about 50 percent of the fixed drive frequency.

In another alternative embodiment, the target minimum resonant oscillation frequency is less than about 75 percent of the fixed drive frequency.

In yet another alternative embodiment, the target minimum resonant oscillation frequency is less than about 90 percent of the fixed drive frequency.

In yet another alternative embodiment, the target minimum resonant oscillation frequency is between 80 percent and 98 percent of the fixed drive frequency.

In yet another alternative embodiment, the target maximum resonant oscillation frequency is more than about 200 percent of the fixed drive frequency.

In yet another alternative embodiment, the target maximum resonant oscillation frequency is more than about 130 percent of the fixed drive frequency.

In yet another alternative embodiment, the target maximum resonant oscillation frequency is more than about 110 percent of the fixed drive frequency.

In yet another alternative embodiment, the target maximum resonant oscillation frequency is between about 102 percent and 125 percent of the fixed drive frequency.

In another aspect, the invention embraces a method for manufacturing laser scanners in which a plurality of light-deflecting assemblies is selected, each light-deflecting assembly having a resonant oscillation frequency that is between a target minimum resonant oscillation frequency and a target maximum resonant oscillation frequency. Laser scanners that include the selected light-deflecting assemblies are configured to drive the selected light-deflecting assemblies at substantially the same fixed drive frequency, wherein the fixed drive frequency is greater than the target minimum resonant oscillation frequency and less than the target maximum resonant oscillation frequency.

In yet another aspect, the invention embraces a method for manufacturing laser scanners in which a plurality of light-deflecting assemblies for use in laser scanners are selected. At least some of the light-deflecting assemblies have substantially different resonant oscillation frequencies from one another. Laser scanners that include the selected light-deflecting assemblies are configured to drive the selected light-deflecting assemblies at substantially the same fixed drive frequency, wherein the fixed drive frequency differs substantially from the respective resonant oscillation frequencies of at least one of the selected light-deflecting assemblies.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 is a flow chart illustrating an exemplary method for manufacturing laser scanners according to the present invention.

FIG. 2 is a line graph illustrating exemplary target frequencies of an exemplary method for manufacturing laser scanners according to the present invention.

### DETAILED DESCRIPTION

The present invention embraces a method for manufacturing laser scanners capable of scanning (e.g., reading) machine-readable indicia such as barcodes, matrix codes, QR codes, etc. These laser scanners typically operate by sweeping a laser beam across a field of view containing the indicia. The laser scanners receive the light that reflects and/or scatters off of the indicia as an optical signal, and the laser scanner converts the optical signal to an electrical signal that can be read (e.g., decoded) by the laser scanners. The type of laser scanners that are embraced by the method according to the present invention achieve the sweeping action of the laser beam across the field of view by projecting a laser beam from a laser source onto a light-deflecting assembly. Typically the light-deflecting assembly includes a mirror to reflect the laser beam in the desired manner, but it may also include a light diffractive element such as a reflection or transmission hologram (i.e., HOE), a light-refractive element such as a lens element, or any other type of optical element capable of deflecting a laser beam along an optical path. The light-deflecting assembly typically also includes a permanent magnet. Typically the mirror and permanent magnet are mounted to a scanning element (e.g., flipper) using an adhesive, or other suitable fastening technique (e.g., soldering).

Typically, the light-deflecting assembly is forced into oscillatory motion (e.g., vibration) by driving an electromagnetic coil with a voltage signal having a frequency (i.e., drive frequency). Typically, the electromagnetic coil is driven in a push-pull mode in which the magnetic polarity of the coil reverses periodically at a rate determined by the amplitude variation of the voltage signal applied across the terminals of the electromagnetic coil. It will be appreciated by a person of ordinary skill in the art that other techniques exist for oscillating the light-deflecting assembly of a laser scanner (e.g., electrodes). The method according to the present invention is not limited to scanners adopting any particular drive method. Rather, the method according to the present invention applies broadly to all laser scanners (or other scanners that operate by sweeping a light beam across a field-of-view that includes an indicia) that incorporate an oscillating light-deflecting assembly.

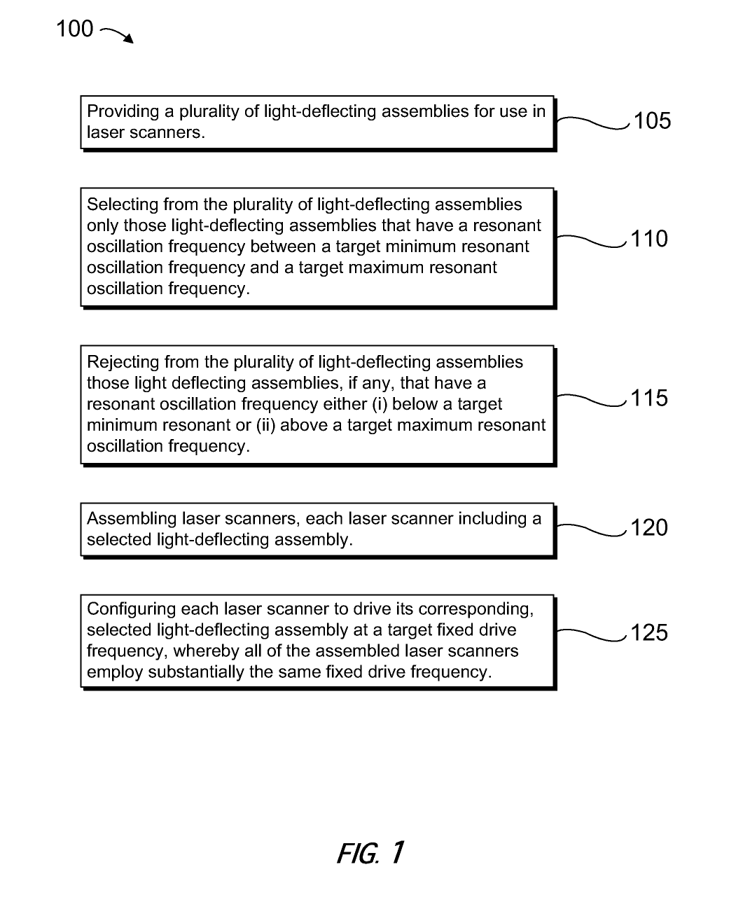

Reference is now made to FIG. 1. According to the method 100 embraced by the present invention, a plurality of light-deflecting assemblies for use in laser scanners is provided 105. A given light-deflecting assembly has a resonant oscillation frequency. The configuration of a light-deflecting assembly (e.g., the components, the weight, the dimensions) can be manipulated to construct a light-deflecting assembly with a specific resonant oscillation frequency. Even among light-deflecting assemblies having the same manufacturing specifications, however, the resonant oscillation frequency typically varies (e.g., ±2.5 Hz from the manufacturing specification for the resonant oscillation frequency) due to differences in materials and/or assembly.

Typically, the closer that a light-deflecting assembly is driven to its resonant oscillation frequency, the greater the efficiency (e.g., the less power required to drive the light-deflecting assembly). Typically, the hinge(s) (e.g., torsional hinge(s)) connecting the light-deflecting assembly to a supporting structure act as torsional springs that resist deflection or rotation forces to return the light-deflecting assembly to its centered position. If the light-deflecting assembly is continuously driven at or near its resonant oscillation frequency, the deflection amplitude of the light-deflecting assembly can increase to a very wide angle. To a degree, this effect is advantageous since it permits oscillation of the light-deflecting assembly over a large angle with a relatively low-power drive signal (e.g., lower voltage). If the deflection amplitude of the light-deflection assembly becomes too great, however, the hinges or other components may become overstressed and fail, or the light-deflecting assembly may collide with other components within the laser scanner (a failure commonly known as a bang). To avoid such failures, some devices are configured such that the drive frequency differs from the resonant frequency of the light-deflecting assembly.

Because changes in temperature tend to lead to drift in the resonant frequency of the light-deflecting assembly, many devices are configured to dynamically adjust the drive frequency to avoid approaching or reaching what may be a changing resonant oscillation frequency of the light-deflecting assembly. Although dynamically varying the drive frequency does avoid the aforementioned device failures caused by a drive frequency in phase with the resonant oscillation frequency, the variable-drive-frequency solution contemplates a more complex design and manufacturing process, and it increases the difficulty of accurately interpreting the optical signals returned (e.g., reflected) from the insignia.

To avoid the complications arising from the variable-drive-frequency solution, the method according to the present invention embraces a fixed drive frequency that remains substantially the same regardless of temperature variations or other factors. Although the use of a fixed drive frequency may, in some situations, result in a fixed drive frequency being in phase with the resonant oscillation frequency, improvements in manufacturing techniques have greatly reduced the likelihood of device failure even at oscillations at the resonant frequency. For example, flippers constructed principally from elastomeric material (e.g., silicone) tend to exhibit self-dampening effects that prohibit the amplitude of the oscillations of the light-deflecting assembly from exceeding tolerances. Since all of the laser scanners to be assembled according to the present method will be driven at substantially the same drive frequency, it is advantageous to incorporate only those light-deflecting assemblies that can be powered in an efficient manner at the selected drive frequency. To achieve this relative uniformity among the light-deflecting assemblies to be incorporated into the assembled laser scanners, a target minimum resonant oscillation frequency and a target maximum resonant oscillation frequency are designated. Only those light-deflecting assemblies that have a resonant oscillation frequency between the designated target minimum resonant oscillation frequency and target maximum resonant oscillation frequency are selected from the plurality of light-deflecting assemblies 110.

Those light-deflecting assemblies, if any, that have a resonant oscillation frequency that is below the target minimum resonant oscillation frequency are rejected 115. The rejected light-deflecting assemblies may be discarded, recycled, or refurbished. Similarly, the light-deflecting assemblies, if any, that have a resonant oscillation frequency above the target maximum resonant oscillation frequency are rejected 115.

After testing of the light-deflecting assemblies is completed, the remaining subgroup from the original plurality of light-deflecting assemblies is a collection of those light-deflecting assemblies that have a resonant oscillation frequency (as tested) that lies between the target minimum resonant oscillation frequency and the target maximum resonant oscillation frequency. It will be appreciated by a person of ordinary skill in the art that this subgroup may contain some, all, or none of the original plurality of light-deflecting assemblies, depending upon such factors as the minimum-maximum target resonant oscillation frequency and the manufacturing consistency of the light-deflecting assemblies. The testing and selection process ensures a desired level of consistency among the selected light-deflection assemblies, thereby ensuring a desired level of operating efficiency (e.g., low voltage requirement) at the selected, substantially the same drive frequency.

The laser scanners are assembled with each laser scanner including a selected light-deflecting assembly 120. Typically, a laser scanner will also include such components as a drive source (e.g., an electromagnetic coil), a digital-to-analog converter (DAC), a light source (e.g., visible laser diode (VLD)), a photoreceptor (e.g., photodiode), a controller (e.g., microcontroller), and a housing (e.g., a hand-supportable housing). When assembled, each laser scanner is configured (e.g., through software) to drive its corresponding, selected light-deflecting assembly at a target fixed drive frequency. As a result, all of the assembled laser scanners employ substantially the same fixed drive frequency for driving each laser scanner's respective light-deflecting assembly. Typically, the laser scanners will be configured to operate the drive source at a fixed drive frequency that is greater than the target minimum resonant oscillation frequency of the light-deflecting assembly and less than the target maximum resonant oscillation frequency of the light-deflecting assembly 125.

The specifications that will determine which light-deflecting assemblies will be included in the assembled laser scanners will vary depending upon the application. For example, where scanning operations require a relatively fast spot speed, a light-deflecting assembly having a relatively high resonant oscillation frequency would typically be employed. For example, if the application required the laser scanner to sweep the laser at a rate of 72 lines per second, then a light-deflecting assembly having a resonant oscillation frequency of about 36 Hz would typically be utilized. In other words, the target resonant oscillation frequency in this example is 36 Hz. The target minimum resonant oscillation frequency and the target maximum resonant oscillation frequency are dependent upon the target resonant oscillation frequency and upon engineering tolerances. Where engineering tolerances permit the laser scanners to include light-deflecting assemblies having resonant oscillation frequencies deviating a relatively greater amount from the target resonant oscillation frequency, then the difference between the target oscillation frequency and the target minimum oscillation frequency will be greater than where engineering tolerances permit less of a deviation from the target resonant oscillation frequency.

In an alternative embodiment, the laser scanners are configured to assess voltage during field use. If the voltage exceeds a predetermined voltage maximum, the laser scanner self assesses the resonant frequency of its incorporated light-deflecting assembly. Furthermore, if (i) the voltage has exceeded the predetermined voltage maximum and (ii) the resonant oscillation frequency of the light-deflecting assembly has deviated too far from the default fixed drive frequency (due to temperature change, for example), the laser scanner can employ an alternative low fixed drive frequency or an alternative high fixed drive frequency. As will be appreciated by those having ordinary skill in the art, the alternative low fixed drive frequency might be employed where the resonant oscillation frequency of the light-deflecting assembly approaches the target minimum resonant frequency, and the alternative high fixed drive frequency might be employed where the resonant oscillation frequency of the light-deflecting assembly approaches the target maximum resonant oscillation frequency. As such, this alternative embodiment employs a default fixed drive frequency for use in most circumstances, and alternative low and high fixed drive frequencies that the laser scanner can deploy during unusual conditions (e.g., extreme temperatures).

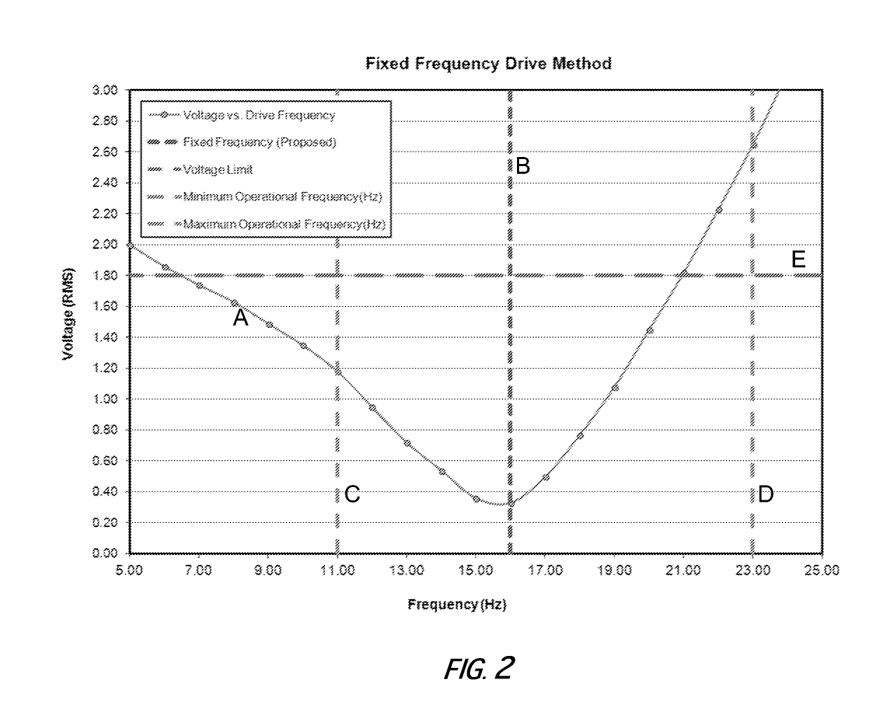

Typically, the determination of the target minimum and target maximum resonant oscillation frequency will be governed, at least in part, by power requirements. As shown in the chart in FIG. 2, a particular light-deflecting assembly having a specific resonant oscillation frequency will require different amounts of power (e.g., voltage) depending upon the drive frequency that is applied. As the drive frequency approaches the resonant oscillation frequency for the given light-deflecting assembly, the voltage required to drive the light-deflecting assembly drops (Line A). Using the method according to the present invention, the fixed drive frequency would be set at or near the resonant oscillation frequency. In the example in FIG. 2, the selected fixed drive frequency, which is the drive frequency requiring the least power, is 16 Hz (Line B). In this example, the acceptable operational limits of the light-deflecting assembly have been determined to be a minimum of 11 Hz (line C) and a maximum of 23 Hz (Line D). In this example illustrated in FIG. 2, operation outside this 11 Hz-23 Hz range is deemed to be system failure. Consequently, light-deflecting assemblies chosen for inclusion in the laser scanners in this example would typically have resonant oscillation frequencies somewhere between 11 Hz and 23 Hz. More typically, the selected light-deflecting assemblies would have a target minimum resonant oscillation frequencies greater than the minimum operational frequency (e.g., at least 1 Hz greater, or, in this example, 12 Hz). Similarly, the selected light-deflecting assemblies would have a target maximum oscillation frequency less than the maximum operational frequency (e.g., at least 4 Hz less, or, in this example, 19 Hz).

It is therefore a feature of the method according to the present invention to permit the selection of a plurality of light-deflecting assemblies having a range of resonant oscillation frequencies, so long as the selected range provides enough of a buffer such that, in the field, the light-deflecting assemblies do not have resonant oscillation frequencies that fall outside of the determined operational ranges due to factors such as temperature changes. The plurality of light-deflecting assemblies selected for use in the laser scanners will typically have at least some of the light-deflecting assemblies that have substantially different resonant oscillation frequencies from one another (e.g., resonant oscillation frequencies that differ by between 5 percent and 15 percent from one another). In some instances where greater variation between the fixed drive frequency and the minimum operational frequency is permitted, the target minimum resonant oscillation frequency is less than about 50 percent (e.g., 48 percent) of the fixed drive frequency. Typically, the target minimum resonant oscillation frequency is less than about 75 percent of the fixed drive frequency. Where it is desirable to have less variation between the fixed drive frequency and the target minimum oscillation frequency, the target minimum resonant oscillation frequency is typically less than about 90 percent (e.g., between about 60 and 85 percent) of the fixed drive frequency. In other instances, the target minimum resonant oscillation frequency is between 80 percent and 98 percent of the fixed drive frequency (for example, between about 90 and 95 percent of the fixed drive frequency).

In the same manner, the variance between the fixed drive frequency and the target maximum resonant oscillation frequency may be smaller or larger depending upon the application. In some instances where greater variation between the fixed drive frequency and the maximum operational frequency is permitted, the target maximum resonant oscillation frequency is more than about 200 percent (e.g., 210 percent) of the fixed drive frequency. Typically, the target maximum resonant oscillation frequency is more than about 130 percent (e.g., 150 percent) of the fixed drive frequency. Where it is desirable to have less variation between the fixed drive frequency and the target maximum oscillation frequency, the target maximum resonant oscillation frequency is typically more than about 110 percent (e.g., between about 115 and 165 percent) of the fixed drive frequency. In other instances, the target maximum resonant oscillation frequency is between 102 percent and 125 percent of the fixed drive frequency (for example, between about 105 and 110 percent of the fixed drive frequency).

To supplement the present disclosure, this application incorporates entirely by reference the following patents, patent application publications, and patent applications: U.S. Pat. No. 6,832,725; U.S. Pat. No. 7,159,783; U.S. Pat. No. 7,128,266; U.S. Pat. No. 7,413,127; U.S. Pat. No. 7,726,575; U.S. Pat. No. 8,390,909; U.S. Pat. No. 8,294,969; U.S. Pat. No. 8,408,469; U.S. Pat. No. 8,408,468; U.S. Pat. No. 8,381,979; U.S. Pat. No. 8,408,464; U.S. Pat. No. 8,317,105; U.S. Pat. No. 8,366,005; U.S. Pat. No. 8,424,768; U.S. Pat. No. 8,322,622; U.S. Pat. No. 8,371,507; U.S. Pat. No. 8,376,233; U.S. Pat. No. 8,457,013; U.S. Pat. No. 8,448,863; U.S. Pat. No. 8,459,557; U.S. Pat. No. 8,469,272; U.S. Pat. No. 8,474,712; U.S. Pat. No. 8,479,992; U.S. Pat. No. 8,490,877; U.S. Patent Application Publication No. 2012/0111946; U.S. Patent Application Publication No. 2012/0223141; U.S. Patent Application Publication No. 2012/0193423; U.S. Patent Application Publication No. 2012/0203647; U.S. Patent Application Publication No. 2012/0248188; U.S. Patent Application Publication No. 2012/0228382; U.S. Patent Application Publication No. 2012/0193407; U.S. Patent Application Publication No. 2012/0168511; U.S. Patent Application Publication No. 2012/0168512; U.S. Patent Application Publication No. 2010/0177749; U.S. Patent Application Publication No. 2010/0177080; U.S. Patent Application Publication No. 2010/0177707; U.S. Patent Application Publication No. 2010/0177076; U.S. Patent Application Publication No. 2009/0134221; U.S. Patent Application Publication No. 2012/0318869; U.S. Patent Application Publication No. 2013/0043312; U.S. Patent Application Publication No. 2013/0068840; U.S. Patent Application Publication No. 2013/0070322; U.S. Patent Application Publication No. 2013/0075168; U.S. Patent Application Publication No. 2013/0056285; U.S. Patent Application Publication No. 2013/0075464; U.S. Patent Application Publication No. 2013/0082104; U.S. Patent Application Publication No. 2010/0225757; U.S. patent application Ser. No. 13/347,219 for an OMNIDIRECTIONAL LASER SCANNING BAR CODE SYMBOL READER GENERATING A LASER SCANNING PATTERN WITH A HIGHLY NON-UNIFORM SCAN DENSITY WITH RESPECT TO LINE ORIENTATION, filed Jan. 10, 2012 (Good); U.S. patent application Ser. No. 13/347,193 for a HYBRID-TYPE BIOPTICAL LASER SCANNING AND DIGITAL IMAGING SYSTEM EMPLOYING DIGITAL IMAGER WITH FIELD OF VIEW OVERLAPPING FIELD OF FIELD OF LASER SCANNING SUBSYSTEM, filed Jan. 10, 2012 (Kearney et al.); U.S. patent application Ser. No. 13/367,047 for LASER SCANNING MODULES EMBODYING SILICONE SCAN ELEMENT WITH TORSIONAL HINGES, filed Feb. 6, 2012 (Feng et al.); U.S. patent application Ser. No. 13/400,748 for a LASER SCANNING BAR CODE SYMBOL READING SYSTEM HAVING INTELLIGENT SCAN SWEEP ANGLE ADJUSTMENT CAPABILITIES OVER THE WORKING RANGE OF THE SYSTEM FOR OPTIMIZED BAR CODE SYMBOL READING PERFORMANCE, filed Feb. 21, 2012 (Wilz); U.S. patent application Ser. No. 13/432,197 for a LASER SCANNING SYSTEM USING LASER BEAM SOURCES FOR PRODUCING LONG AND SHORT WAVELENGTHS IN COMBINATION WITH BEAM-WAIST EXTENDING OPTICS TO EXTEND THE DEPTH OF FIELD THEREOF WHILE RESOLVING HIGH RESOLUTION BAR CODE SYMBOLS HAVING MINIMUM CODE ELEMENT WIDTHS, filed Mar. 28, 2012 (Havens et al.); U.S. patent application Ser. No. 13/492,883 for a LASER SCANNING MODULE WITH ROTATABLY ADJUSTABLE LASER SCANNING ASSEMBLY, filed Jun. 10, 2012 (Hennick et al.); U.S. patent application Ser. No. 13/367,978 for a LASER SCANNING MODULE EMPLOYING AN ELASTOMERIC U-HINGE BASED LASER SCANNING ASSEMBLY, filed Feb. 7, 2012 (Feng et al.); U.S. patent application Ser. No. 13/852,097 for a System and Method for Capturing and Preserving Vehicle Event Data, filed Mar. 28, 2013 (Barker et al.); U.S. patent application Ser. No. 13/780,356 for a Mobile Device Having Object-Identification Interface, filed Feb. 28, 2013 (Samek et al.); U.S. patent application Ser. No. 13/780,158 for a Distraction Avoidance System, filed Feb. 28, 2013 (Sauerwein); U.S. patent application Ser. No. 13/784,933 for an Integrated Dimensioning and Weighing System, filed Mar. 5, 2013 (McCloskey et al.); U.S. patent application Ser. No. 13/785,177 for a Dimensioning System, filed Mar. 5, 2013 (McCloskey et al.); U.S. patent application Ser. No. 13/780,196 for Android Bound Service Camera Initialization, filed Feb. 28, 2013 (Todeschini et al.); U.S. patent application Ser. No. 13/792,322 for a Replaceable Connector, filed Mar. 11, 2013 (Skvoretz); U.S. patent application Ser. No. 13/780,271 for a Vehicle Computer System with Transparent Display, filed Feb. 28, 2013 (Fitch et al.); U.S. patent application Ser. No. 13/736,139 for an Electronic Device Enclosure, filed Jan. 8, 2013 (Chaney); U.S. patent application Ser. No. 13/771,508 for an Optical Redirection Adapter, filed Feb. 20, 2013 (Anderson); U.S. patent application Ser. No. 13/750,304 for Measuring Object Dimensions Using Mobile Computer, filed Jan. 25, 2013; U.S. patent application Ser. No. 13/471,973 for Terminals and Methods for Dimensioning Objects, filed May 15, 2012; U.S. patent application Ser. No. 13/895,846 for a Method of Programming a Symbol Reading System, filed Apr. 10, 2013 (Corcoran); U.S. patent application Ser. No. 13/867,386 for a Point of Sale (POS) Based Checkout System Supporting a Customer-Transparent Two-Factor Authentication Process During Product Checkout Operations, filed Apr. 22, 2013 (Cunningham et al.); U.S. patent application Ser. No. 13/888,884 for an Indicia Reading System Employing Digital Gain Control, filed May 7, 2013 (Xian et al.); U.S. patent application Ser. No. 13/895,616 for a Laser Scanning Code Symbol Reading System Employing Multi-Channel Scan Data Signal Processing with Synchronized Digital Gain Control (SDGC) for Full Range Scanning, filed May 16, 2013 (Xian et al.); U.S. patent application Ser. No. 13/897,512 for a Laser Scanning Code Symbol Reading System Providing Improved Control over the Length and Intensity Characteristics of a Laser Scan Line Projected Therefrom Using Laser Source Blanking Control, filed May 20, 2013 (Brady et al.); U.S. patent application Ser. No. 13/897,634 for a Laser Scanning Code Symbol Reading System Employing Programmable Decode Time-Window Filtering, filed May 20, 2013 (Wilz, Sr. et al.); U.S. patent application Ser. No. 13/902,242 for a System For Providing A Continuous Communication Link With A Symbol Reading Device, filed May 24, 2013 (Smith et al.); U.S. patent application Ser. No. 13/902,144, for a System and Method for Display of Information Using a Vehicle-Mount Computer, filed May 24, 2013 (Chamberlin); U.S. patent application Ser. No. 13/902,110 for a System and Method for Display of Information Using a Vehicle-Mount Computer, filed May 24, 2013 (Hollifield); U.S. patent application Ser. No. 13/912,262 for a Method of Error Correction for 3D Imaging Device, filed Jun. 7, 2013 (Jovanovski et al.); U.S. patent application Ser. No. 13/912,702 for a System and Method for Reading Code Symbols at Long Range Using Source Power Control, filed Jun. 7, 2013 (Xian et al.); U.S. patent application Ser. No. 13/922,339 for a System and Method for Reading Code Symbols Using a Variable Field of View, filed Jun. 20, 2013 (Xian et al.); U.S. patent application Ser. No. 13/927,398 for a Code Symbol Reading System Having Adaptive Autofocus, filed Jun. 26, 2013 (Todeschini); U.S. patent application Ser. No. 13/930,913 for a Mobile Device Having an Improved User Interface for Reading Code Symbols, filed Jun. 28, 2013 (Gelay et al.); U.S. patent application Ser. No. 13/933,415 for an Electronic Device Case, filed Jul. 2, 2013 (London et al.); and U.S. patent application Ser. No. 13/947,296 for a System and Method for Selectively Reading Code Symbols, filed Jul. 22, 2013 (Rueblinger et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A method for manufacturing laser scanners, comprising:
providing a plurality of light-deflecting assemblies [flippers] for use in laser scanners;
selecting from the plurality of light-deflecting assemblies only those light-deflecting assemblies that have a resonant oscillation frequency between a target minimum resonant oscillation frequency and a target maximum resonant oscillation frequency;
rejecting from the plurality of light-deflecting assemblies those light-deflecting assemblies, if any, that have a resonant oscillation frequency either (i) below a target minimum resonant oscillation frequency or (ii) above a target maximum resonant oscillation frequency;
assembling laser scanners, each laser scanner including a selected light-deflecting assembly; and
configuring each laser scanner to drive its corresponding, selected light-deflecting assembly at a target fixed drive frequency, whereby all of the assembled laser scanners employ substantially the same fixed drive frequency.

2. The method according to claim 1, wherein the target minimum resonant oscillation frequency is less than about 50 percent of the fixed drive frequency.

3. The method according to claim 1, wherein the target minimum resonant oscillation frequency is less than about 75 percent of the fixed drive frequency.

4. The method according to claim 1, wherein the target minimum resonant oscillation frequency is less than about 90 percent of the fixed drive frequency.

5. The method according to claim 1, wherein the target minimum resonant oscillation frequency is between 80 percent and 98 percent of the fixed drive frequency.

6. The method according to claim 1, wherein the target maximum resonant oscillation frequency is more than about 200 percent of the fixed drive frequency.

7. The method according to claim 1, wherein the target maximum resonant oscillation frequency is more than about 130 percent of the fixed drive frequency.

8. The method according to claim 1, wherein the target maximum resonant oscillation frequency is more than about 110 percent of the fixed drive frequency.

9. The method according to claim 1, wherein the target maximum resonant oscillation frequency is between about 102 percent and 125 percent of the fixed drive frequency.

10. A method for manufacturing laser scanners, comprising:
selecting a plurality of light-deflecting assemblies, each light-deflecting assembly having a resonant oscillation frequency that is between a target minimum resonant oscillation frequency and a target maximum resonant oscillation frequency; and
configuring laser scanners that include the selected light-deflecting assemblies to drive the selected light-deflecting assemblies at substantially the same fixed drive frequency, wherein the fixed drive frequency is greater than the target minimum resonant oscillation frequency and less than the target maximum resonant oscillation frequency.

11. The method according to claim 10, wherein the target minimum resonant oscillation frequency is less than about 50 percent of the fixed drive frequency.

12. The method according to claim 10, wherein the target minimum resonant oscillation frequency is less than about 75 percent of the fixed drive frequency.

13. The method according to claim 10, wherein the target minimum resonant oscillation frequency is less than about 90 percent of the fixed drive frequency.

14. The method according to claim 10, wherein the target minimum resonant oscillation frequency is between 80 percent and 98 percent of the fixed drive frequency.

15. The method according to claim 10, wherein the target maximum resonant oscillation frequency is more than about 200 percent of the fixed drive frequency.

16. The method according to claim 10, wherein the target maximum resonant oscillation frequency is more than about 130 percent of the fixed drive frequency.

17. The method according to claim 10, wherein the target maximum resonant oscillation frequency is more than about 110 percent of the fixed drive frequency.

18. The method according to claim 10, wherein the target maximum resonant oscillation frequency is between about 102 percent and 125 percent of the fixed drive frequency.

19. A method for manufacturing laser scanners, comprising:
selecting a plurality of light-deflecting assemblies for use in laser scanners, wherein at least some of the light-deflecting assemblies have substantially different resonant oscillation frequencies from one another; and
configuring laser scanners that include the selected light-deflecting assemblies to drive the selected light-deflecting assemblies at substantially the same fixed drive frequency, wherein the fixed drive frequency differs substantially from the respective resonant oscillation frequencies of at least one of the selected light-deflecting assemblies.
